(19) United States
(12) Patent Application Publication
(10) Pub. No.: US 2010/0085905 A1
(43) Pub. Date: Apr. 8, 2010

(54) COMMUNICATION SYSTEM AND WIRELESS COMMUNICATION DEVICE

(76) Inventor: Kiyotaka MATSUE, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/560,892

(22) Filed: Sep. 16, 2009

(30) Foreign Application Priority Data
Oct. 3, 2008 (JP) 2008-258512

(51) Int. Cl. H04W 84/12; H04H 20/71

(52) U.S. Cl. 370/312; 370/338

(57) ABSTRACT

A communication system includes a center station communication device and a plurality of local station communication devices. The center station communication device includes a transmission unit which transmits first data including reference information to the local station communication devices, the reference information being used for switching the local station communication devices from an active state to a waiting state for a period of one-to-many communication in which the center station communication device transmits second data to the local station communication devices. Each of the local station communication devices includes a receiving unit receiving the first data and the second data from the center station communication device and a state switching unit which, for the period of one-to-many communication, switches from the active state to the standby state based on the reference information.

### CROSS-REFERENCE TO RELATED APPLICATIONS

This application is based upon and claims the benefit of priority from prior Japanese Patent Application No. 2008-258512, filed Oct. 3, 2008, the entire contents of which are incorporated herein by reference.

### BACKGROUND OF THE INVENTION

1. Field of the Invention

The present invention relates to a communication system and a wireless communication device.

2. Description of the Related Art

IEEE 802.11, which is a standard for wireless LAN communication, includes many derivative standards (including standards prepared by working groups). Examples of the wireless LAN standards include IEEE 802.11 standards such as IEEE 802.11a/b/g/e/n.

In a wireless LAN communication environment complying with the IEEE 802.11 standards, a communication device (access point) AP of a center station transmits a beacon frame, a broadcast (BC) frame and/or a multicast (MC) frame, and a unicast (UC) frame to communication devices (stations) STA of local stations in this order.

The beacon and BC frames are received by all the local station communication devices STA. Furthermore, the MC and UC frames are received by only particular local station communication device STA. Each local station communication device STA cannot transfer from an awake state to a doze state until receiving the beacon and BC frames and receiving of the MC frame transmitted after the BC frame are completed, and can transfer from the awake state to the doze state after receiving of the MC frame is completed. In this manner, the above-described standards specify that the local station communication device STA needs to remain the awake state until the completion of receiving the MC frame.

The conventional BC frame is basically transmitted to all terminals and necessarily received by all the local station communication devices STA. However, some of the frames transmitted as BC frames are not required for all the local station communication devices STA. For example, a frame of TCP/IP control protocol or a frame for network system management is not required for all the local station communication devices STA.

Furthermore, a case of the MC frame is same as a case of the BC frame. In the conventional standards, even if the MC frame is not required for a particular local station communication device STA belonging to a transmission destination group of the MC frame, the MC frame is received by all the local station communication devices STA belonging to the translation destination group.

Receiving an unnecessary frame increases a duration for which the local station communication device STA stays the awake state. As a result, the local station communication device STA wastes extra power.

Jpn. Pat. Appln. KOKAI Publication No. 2005-303585 discloses a receiving control method involving receiving a transmission frame transmitted by another station, demodulating the transmission frame to generate a received frame, analyzing header information in the received frame, and based on the header information, stopping the receiving transmission frames for a predetermined time.

Jpn. Pat. Appln. KOKAI Publication No. 2006-115414 discloses a wireless communication device including M receiving sections connected to respective antennas, a frame analysis section analyzing received signals received by the M received sections, and a selection section selecting an used receiving section among the M reception sections. The selection section of the wireless communication device selects P of the M receiving sections based on the result of analysis by the frame analysis section.

### BRIEF SUMMARY OF THE INVENTION

According to a first aspect of the invention, there is provided a communication system comprising a center station communication device and local station communication devices, wherein the center station communication device comprises: a transmission unit which transmits first data including reference information to the local station communication devices, the reference information being used for switching the local station communication devices from an active state to a waiting state for a period of one-to-many communication in which the center station communication device transmits second data to the local station communication devices, and each of the local station communication devices comprises: a receiving unit receiving the first data and the second data from the center station communication device; and a state switching unit which, for the period of one-to-many communication, switches from the active state to the waiting state based on the reference information.

According to a second aspect of the invention, there is provided wireless communication device performing wireless LAN communication complying with at least one of IEEE 802.11 standards, comprising: a receiving unit receiving, from a center station communication device, a frame including reference information used for switching a local station communication device from an active state to a waiting state according to at least one of a broadcast communication scheme and a multicast communication scheme; a determination unit determining, based on the reference information, whether to maintain the active state or to switch to the waiting state according to at least one of the broadcast communication scheme and the multicast communication scheme; and a state switching unit switching the local station communication device from the active state to the waiting state according to at least one of the broadcast communication scheme and the multicast communication scheme when a result of a determination by the determination unit indicates the switching to the waiting state.

According to a third aspect of the invention, there is provided A wireless communication device performing wireless LAN communication complying with at least one of IEEE 802.11 standards, the device comprising: a frame generation unit generating a beacon frame or an independent management frame including the reference information required to switch a local station communication device from an active state to a waiting state according to at least of one of a broadcast communication scheme and a multicast communication scheme; and a transmission unit transmitting the beacon frame or the independent management frame, and a frame based on at least one of the broadcast communication scheme and the multicast communication scheme, to a plurality of the local station communication devices.

### BRIEF DESCRIPTION OF THE SEVERAL VIEWS OF THE DRAWING

FIG. 1 is a diagram showing the configuration of an example of a communication system according to a first embodiment of the present invention;

FIG. 2 is a block diagram showing an example of the configuration of the communication system according to the first embodiment of the present invention;

FIG. 3 is a diagram showing an example of comparison between conventional state switching and state switching according to the first embodiment in a local station communication device;

FIG. 4 is a block diagram showing an example of a hardware configuration of a communication device according to the first embodiment;

FIG. 5 is a block diagram showing an example of software in a master communication device according to the first embodiment;

FIG. 6 is a block diagram showing an example of software in the local station communication device according to the first embodiment;

FIG. 7 is a flowchart showing an example of a frame receiving process in the local station communication device according to the first embodiment;

FIG. 8 is a diagram of a transmission process in a center station communication device according to a second embodiment of the present invention;

FIG. 9 is a diagram showing an example of a receiving process in a local station communication device according to the second embodiment;

FIG. 10 is a diagram showing an example of a format of a reference element used in a communication system according to the second embodiment;

FIG. 11 is a diagram illustrating a method for specifying a local station communication device and a method for specifying a switch timing for each type of reference elements;

FIG. 12 is a diagram showing an example of specific contents of the reference element; and

FIG. 13 is a sequence diagram showing an example of communication in a communication system according to the second embodiment.

### DETAILED DESCRIPTION OF THE INVENTION

Embodiments of the present invention will be described below with reference to the drawings. In the description, components common to all the drawings are denoted by the same reference numerals.

In the description of the embodiments, by way of example, a communication device of a center station communicates with a plurality of communication devices of local station based on a protocol complying with at least one of the IEEE 802.11 standards. However, the present invention is also applicable when communication is performed based on another one-to-many communication protocol.

### First Embodiment

A local station communication device (Station) STA according to the present embodiment is used in a wireless LAN communication environment. The local station communication device STA comprises a function corresponding to a partly changed power save mode function specified in IEEE 802.11. The present communication scheme thus allows a further reduction in power consumption compared to the conventional communication scheme.

More specifically, in the wireless LAN communication complying with IEEE 802.11, the local station communication device is in an awake state (active state) during a communication of a beacon, BC, and MC frame transmitted by a center station communication device (Access point). In the conventional communication, during transmission and receiving BC and MC frames, the local station communication device STA is not switched to a doze state (waiting state). However, in the present embodiment, if any of the BC and MC frames is not required for the local station communication device STA, the local station communication device STA switches from the awake state to the doze state. The local station communication device STA then executes a process of discarding an unnecessary frame. Thus, the power consumption by the local station communication device STA is reduced to achieve reduced power consumption.

In the description of the embodiment, by way of example, in the wireless LAN communication complying with at least one of the IEEE 802.11 standards, whether or not a frame received by the local station communication device STA is required is determined with reference to a destination address (for example, a MAC address) in the frame. However, reference information used to switch the local station communication device STA from an active state to a waiting state is not limited to the destination address; any of various pieces of information may be used as reference information.

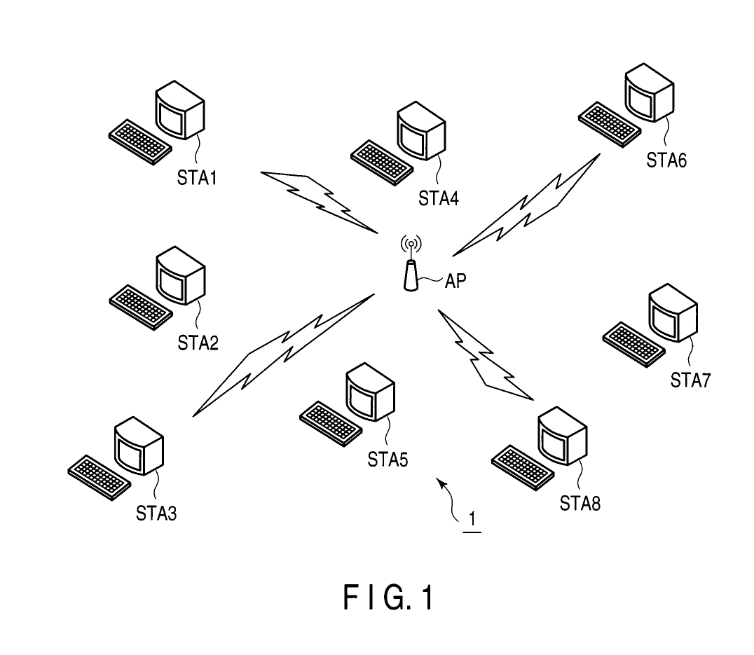

FIG. 1 is a diagram showing an example of a configuration of a communication system according to the present embodiment.

A communication system 1 is a wireless LAN communication system. The communication system 1 enables wireless LAN communication complying with at least one of the IEEE 802.11 standards.

A center station communication device (data transmission side) AP communicate with a plurality of local station communication devices (data receiving side) STA1 to STA8. The number of the local station communication devices is freely variable.

In the communication system 1, during a communication of BC and MC frames, each of the local station communication devices STA1 to STA8 is operable either in the awake state or in the doze state (reduced power consumption state).

In the present embodiment, it is assumed that during a period of BC and MC communication, frames are communicated based on at least one of the BC communication scheme and the MC communication scheme.

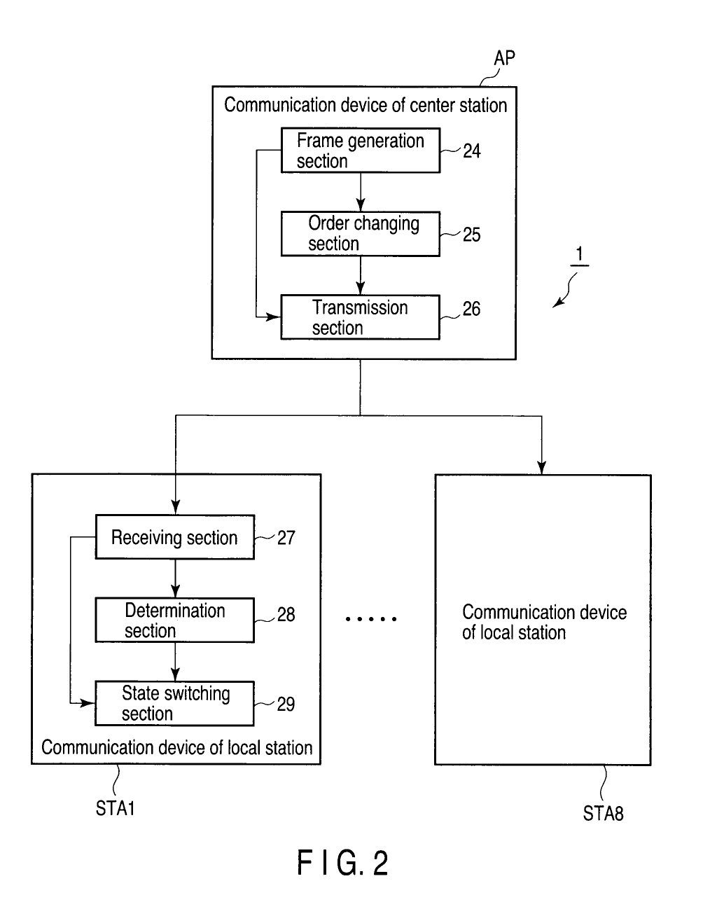

FIG. 2 is a block diagram showing an example of a configuration of the communication system 1 according to the present embodiment.

The center station communication device AP includes a frame generation section 24, an order changing (resequencing) section 25, and a transmission section 26.

The frame generation section 24 generates beacon, BC, MC, and UC frames. Each of the generated frames includes a destination address, for example, a MAC address.

For at least one of the transmission of BC frames and the transmission of MC frames, the order changing section 25 changes a transmission order (sequence) of the frames to be transmitted in the BC frame communication and the frames to be transmitted in the MC frame communication so that the center station communication device first transmits receiving target frames required for any of the local station communication devices STA1 to STA8 and which are to be received by the local station side and then transmits other frames that need not be received by the local station communication devices STA1 to STA8.

Examples of the receiving target frames to be received by the local station communication devices STA1 to STA8 include frames transmitted to the local station communication devices STA1 to STA8, BC frames with high priorities for receiving by the local station communication devices STA1 to STA8, MC frames with high priorities, BC frames to be received by all the local station communication devices STA1 to STA8 in common, and MC frames to be received in common.

In contrast, examples of the other frames that need not be received by the local station communication devices STA1 to STA8 include frames that are not required for all the local station communication devices STA, for example, frames with low priorities, frames already transmitted to the local station communication devices STA1 to STA8 and not updated since a previous transmission timing, frames based on a TCP/IP control protocol, and network management frames. Even if a destination of a frame indicates a certain local station communication device STA, the frame may not be required for the local station communication device STA.

The transmission section 26 transmits the beacon frame generated by the frame generation section 24, the BC and MC frames the sequence of which has been changed by the order changing section 25, and the UC frame generated by the frame generation section 24. The transmission section 26 thereafter repeats a similar transmission operation.

Each of the local station communication devices STA1 to STA8 includes a receiving section 27, a determination section 28, and a state switching section 29.

The receiving section 27 receives the beacon frame, the BC frame and/or MC frame, and the UC frame.

The determination section 28 determines whether or not each of the BC, MC, and UC frame sequentially received by the receiving section 27 is required (for example, whether or not the destination address of each frame corresponds to the address of the local station communication device).

When the beacon frame is received, the state switching section 29 sets the awake state.

Then, during the communication of BC frame and/or MC frame, if the determination section 28 determines that the received BC frame and/or MC frame are required (for example, the destination address is determined to indicate the local station communication device), the state switching section 29 maintains the awake state. If the determination section 28 determines that the received BC frame and/or MC frame are not required (for example, the destination address is determined not to indicate the local station communication device), the state switching section 29 switches the awake state to the doze state.

Then, during the communication of UC frames, if the determination section 28 determines that the received UC frame is required (for example, the destination address is determined to indicate the slave communication device), the state switching section 29 maintains the awake state. If the determination section 28 determines that the received UC frame is not required (for example, the destination address is determined not to indicate the slave communication device), the state switching section 29 switches the awake state to the doze state.

In the present embodiment, when the period of the communication of BC and MC frames is reached, the appropriate local station communication device STA1 to STAB in the awake state is switched to the doze state. Thereafter, upon receiving the required UC frame during the communication of UC frames, the local station communication device STA1 to STA8 is switched to the awake state to receive the UC frame transmitted to the local station communication device. However, alternatively, to receive the required UC frame after the period of the communication of BC and MC frames, the local station communication device STA1 to STA8 may stay awake from the end of the period of the communication of BC and MC frames until completion of the receiving the required UC frame. Once the receiving the required UC frame is completed, the local station communication devices STA1 to STA8 may transition from the awake state to the doze state. In this variation, the local station communication device STA1 to STA8 pre-receives information indicating that the required UC frame is to be transmitted and received, from the center station communication device AP. Then, only when the information indicates that the required UC frame is not to be received after the period of the communication of BC and MC frames, the local station communication device STA1 to STA8 permits the switching from the awake state to the doze state for the period of the communication of BC and MC frames.

Moreover, while holding a frame to be transmitted to another communication device, the local station communication device STA1 to STA8 may stay awake.

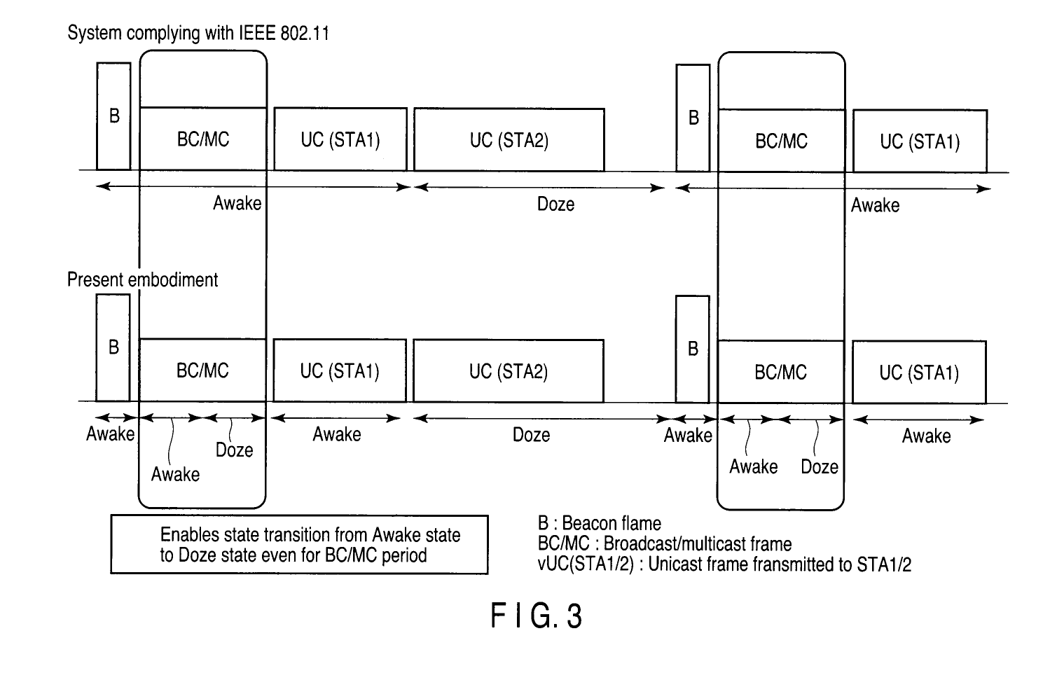

FIG. 3 shows an example of comparison between the conventional state switching and the state switching according to the present embodiment in the local station communication device STA1. FIG. 3 will be described using the local station communication device STA1. However, the description also applies to the other local station communication devices STA2 to STA8.

In the communication system 1 according to the present embodiment, the center station communication device AP sequentially transmits a beacon frame, a BC and MC frame, and a UC frame to the local station communication device STA1. Thereafter, the transmission of a beacon frame, a BC and MC frame, and a UC frame is similarly repeated.

Upon receiving the beacon frame, the local station communication device STA1 normally transitions to the awake state. After receiving the beacon frame, the local station communication device STA1 receives the BC and MC frames. Thus, during the receiving BC and MC frames, the local station communication device STA1 is awake. Thereafter, when the period of the receiving UC frames is reached, the local station communication device STA1 is ready to transition from the awake state to the doze state. The local station communication device STA1 stays awake until completion of the receiving a UC frame transmitted to the local station communication device STA1. When receiving a UC frame transmitted to another local station communication device after completing the receiving the UC frame transmitted to the local station communication device STA1, the local station communication device STA1 transitions to the doze state. Thereafter, upon receiving the next beacon frame, the local station communication device STA1 transitions to the awake state and then repeats a similar operation. The above-described state transitions correspond to operations by a wireless LAN terminal compliant with the standards.

In contrast, the local station communication device STA1 according to the present embodiment references the MAC address of the received BC and MC frames indicating the destination. Then, even when the period of the communication of BC and MC frames is reached, during which the local station communication device STA1 conventionally needs to be awake as described above, if the MAC address does not indicate the local station communication device STA1, the local station communication device STA1 transitions from the awake state to the doze state. Thus, the opportunity of receiving the BC and MC frames not required for STA1 is minimized.

FIG. 3 shows that during the communication of BC and MC frames, the local station communication device switches between the awake state and the doze state. However, in the present embodiment, during the communication of BC and MC frames, the local station communication device may stay awake (when the local station communication device is in compliance with the standards) or continue to doze.

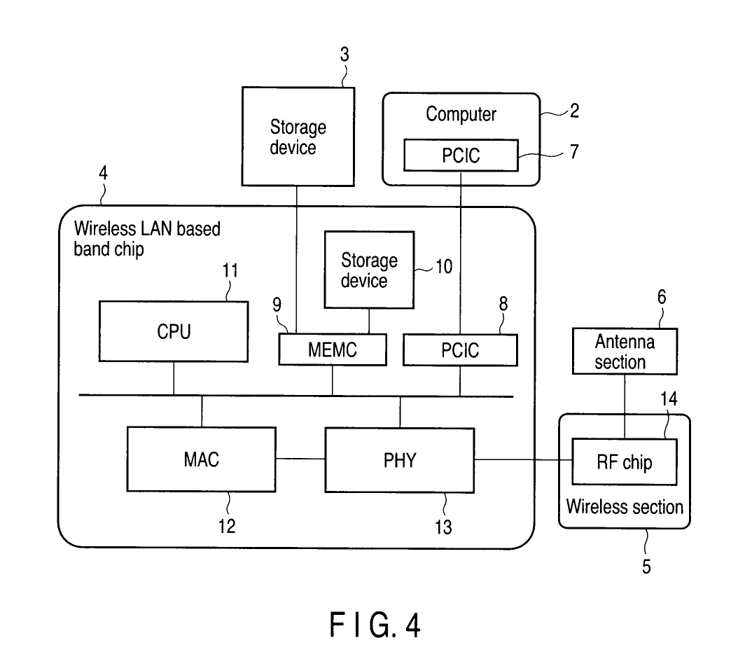

FIG. 4 is a block diagram showing an example of the hardware configuration of the communication devices AP and STA1 to STA8 according to the present embodiment.

The center station communication device AP according to the present embodiment includes a computer 2, a storage device 3, for example, SDRAM, a wireless LAN baseband chip 4, a wireless section 5, and an antenna section 6.

In the center station communication device AP, the computer 2 transmits data to be transmitted, from a computer 2-side peripheral component interconnect controller (PCIC) 7 through a baseband chip 4-side PCIC 8 to a memory controller (MEMC) 9. The data is then stored in a storage device 10 or a storage device 3, for example SRAM. In this manner, the storage devices 3 and 10 are accessed using MEMO 9.

CPU 11 accesses the data stored in the storage device 3 or 10, via MEMC. CPU 11 executes processing required for data transmission to output the processed data to the wireless section 5 via a medium access controller (MAC) 12 and a physical layer (PHY) 13.

The processed data is passed from an RF chip 14 in the wireless section 5 to the antenna section 6 and thus transmitted as frames for wireless LAN communication.

Each of the local station communication devices STA1 to STA8 performs operations opposite to those of the center station communication device AP.

Various functions executed by the communication devices according to the present embodiment can be implemented either by software or by hardware. For hardware, the functions can be implemented by, for example, MAC 12. For software, the functions can be implemented by, for example, CPU 11.

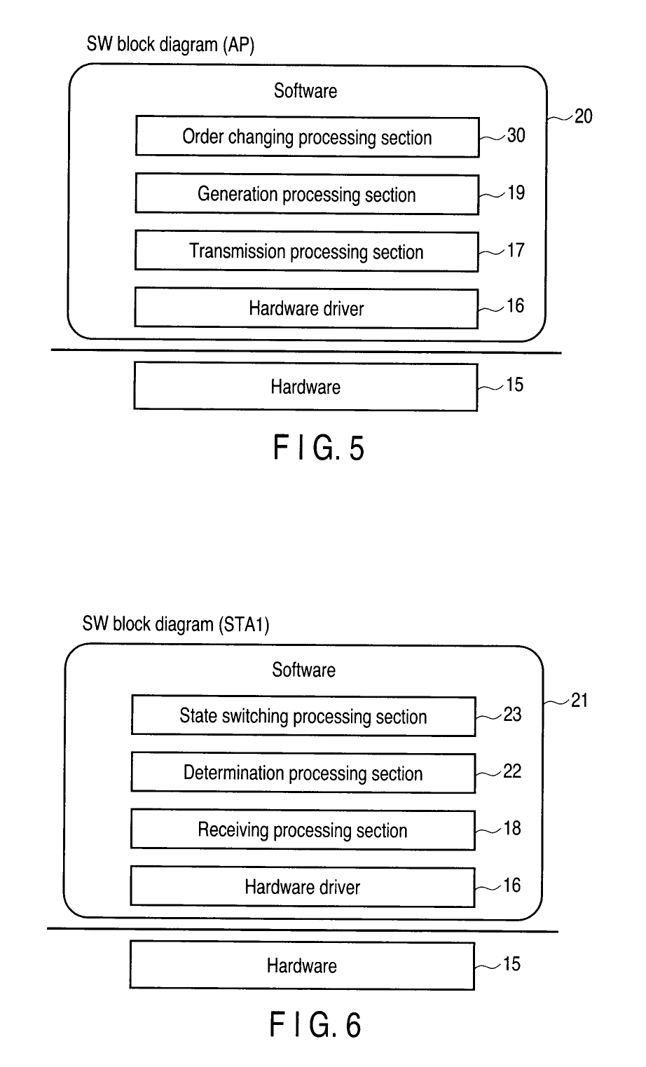

FIG. 5 is a block diagram showing an example of software for the center station communication device AP according to the present embodiment.

As shown in FIG. 5, in the center station communication device AP, software 20 and hardware 15 cooperate in implementing communication processing. The software 20 in AP includes a generation processing section 19, an order changing processing section 30, a transmission processing section 17, and a hardware driver 16.

The generation processing section 19 generates frames to be transmitted to the local station communication devices STA1 to STA8. The generation processing section 19 passes generated frames to the transmission processing section 17 or the order changing processing section 30. For example, the generation processing section 19 passes a beacon frame and a UC frame to the transmission processing section 17, while passing BC and MC frames to the resequencing processing section 30.

The resequencing processing section 30 changes the sequence of the BC and MC frames so that those of the frames to be received by the local station communication device STA1 to STA8 are first transmitted and the other frames that need not be received by the local station communication device STA1 to STA8 are then transmitted. The order changing processing section 30 passes the changed order of frames to the transmission processing section 17.

The transmission processing section 17 transmits the frames received from the generation processing section 19 or the order changing processing section 30 to the hardware 15 controlled by the hardware driver 16, for example, in the order of beacon frame, BC and MC frames, and UC frame.

The hardware 15 transmits the frames received from the software 20, to the local station communication device STA1 to STA8 via the wireless section 5 or the like.

FIG. 6 is a block diagram showing an example of the software for the local station communication device STA1 to STA8 according to the present embodiment. The block diagram also applies to the other local station communication devices STA2 to STA8.

As shown in FIG. 6, as in the case of the center station communication device AP, in the local station communication device STA1, software 21 and hardware 51 cooperate in executing communication processing. The software 21 in the local station communication device STA1 includes the hardware driver 16, a receiving processing section 18, a determination processing section 22, and a state switch processing section 23.

The hardware 15 receives the frames transmitted by the center station communication device AP, via the wireless section 5 and the like.

The frames received by the hardware 15 controlled by the hardware driver 16 are passed to the receiving processing section 18.

The receiving processing section 18 executes a process of receiving the frames received from hardware 15.

The frames received by the receiving processing section 18 are passed to the determination processing section 22.

Upon receiving the BC and MC frames, the determination processing section 22 references the MAC address stored in the BC and MC frames to determine whether or not the address in the BC and MC frames indicates the local station communication device STA1. Furthermore, upon receiving the UC frame, the determination processing section 19 references the MAC address stored in the UC frame to determine whether or not the address in the UC frame indicates the local station communication device STA1.

Upon receiving the beacon frame, the state switching section 23 sets the awake state.

During the period of the communication of BC and MC frames, if the determination processing section 22 determines that the MAC address in the BC and MC frames indicates the local station communication device STA1 (the determination processing section 22 determines that the BC and MC frames are required), the state switching section 23 sets the awake state. If the determination processing section 22 determines that the MAC address in the BC and MC frames does not indicate the local station communication device STA1 (the determination processing section 22 determines that the BC and MC frames are not required), the state switching section 23 sets the doze state.

If information has been received which indicates that a UC frame transmitted to the local station communication device STA1 is to be transmitted and received later, the state switching processing section 23 may maintain the awake state regardless of the contents of the MAC address.

Moreover, during the communication of UC frames, if the determination processing section 22 determines that the MAC address in the UC frame indicates the local station communication device STA1 (the determination processing section 22 determines that the UC frame is required), the state switching processing section 23 sets the awake state. If the determination processing section 22 determines that the MAC address in the UC frame does not indicate the local station communication device STA1 (the determination processing section 22 determines that the UC frame is not required), the state switching processing section 23 sets the doze state.

An example of the operation of the communication system 1 according to the present embodiment configured as described above will be described below.

In a wireless LAN system complying with the IEEE 802.11 standards, the local station communication devices STA1 to STA8 use a power save function to allow a reduction in power consumption. The function enables each of the local station communication devices STA1 to STA8 to transition from the awake state to the doze state.

After receiving a beacon frame transmitted by the center station communication device AP and including a Delivery Traffic Interval Message (DTIM) and before receiving the next beacon frame (during the interval of receiving the beacon frame), each of the local station communication devices STA1 to STA8 normally transitions from the doze state to the awake state. Furthermore, during the receiving BC and MC frames consecutively transmitted by the center station communication device AP after the receiving the beacon frame, the local station communication devices STA1 to STA8 are awake. Thereafter, once the period of the receiving UC frames is reached, the local station communication devices STA1 to STA8 can transition from the awake state to the doze state. This corresponds to a transition in the state of a wireless LAN terminal complying with the standards.

In the present embodiment, with reference to the destination addresses (destination MAC addresses) in the received frames, each of the local station communication devices STA1 to STA8 can transition to the doze state even during the receiving BC and MC frames, when according to the conventional protocol, the local station communication device needs to be awake.

For example, it is assumed that vide data is periodically transmitted to the local station communication devices STA1 to STA8 through distribution of MC frames. Upon referencing the MAC address in the MC frame to determine that the video data is not required, the local station communication devices STA1 to STA8 execute a frame discarding process. Concurrently with the frame discarding process, the local station communication device STA1 to STA8 transition from the awake state to the doze state.

If the local station communication devices STA1 to STA8 need to receive the subsequent UC frame or hold a frame to be transmitted, the local station communication devices STA1 to STA8 may stay awake.

Furthermore, the above-described operation also applies to BC frames. For example, it is assumed that according to a protocol (routing protocol, monitoring protocol, or the like) on TCP/IP for controlling the network, a BC frame is transmitted from the center station communication device AP to the local station communication device STA1 to STA8. In this case, the local station communication devices STA1 to STA8 reference the MAC address in the BC frame. Thus, when the received frame is determined to be a BC frame, the local station communication device STA1 to STA8 references a port number in a body section. The local station communication devices STA1 to STA8 execute a process of determining the type of the frame, for example, whether or not the frame is complying with the control protocol, to determine whether or not the BC frame is required. As a result, if the BC frame is not required, the local station communication devices STA1 to STA8 transition from the awake state to the doze state. If BC frame is required, the local station communication devices STA1 to STA8 stay awake state and execute a frame reception process and a protocol receiving process.

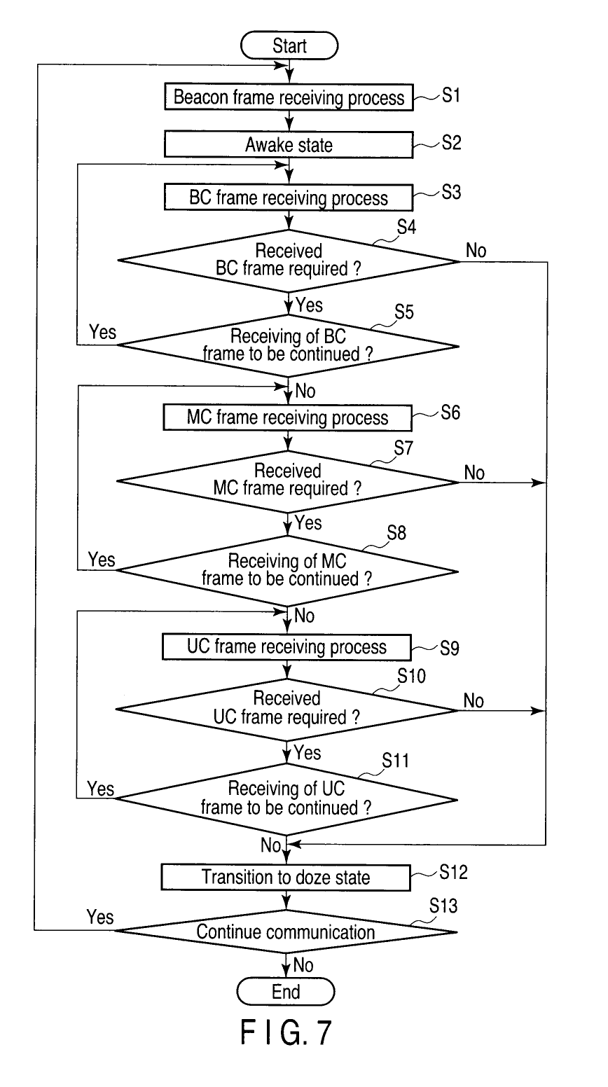

FIG. 7 is a flowchart showing an example of the frame receiving process in each of the local station communication devices STA1 to STA8 according to the present embodiment.

During the communication of BC and MC frames, the local station communication devices STA1 to STA8 can be switched between the awake state and the doze state. With reference to the flowchart in FIG. 7, a version will be described in which after switching to the doze state, the local station communication devices STA1 to STA8 are kept in the doze state until receiving the next beacon frame.

In step S1, the local station communication devices STA1 to STA8 execute a process of receiving a beacon frame.

In step S2, the local station communication devices STA1 to STA8 set the awake state in response to the receiving the beacon frame.

In step S3, the local station communication devices STA1 to STA8 execute a process of receiving a BC frame.

In step S4, the local station communication devices STA1 to STA8 execute a first determination process of determining whether or not the received BC frame is required.

If the result of the first determination process indicates that the received BC frame is not required, the process shifts to step S12.

If the result of the first determination process indicates that the received BC frame is required, then in step S5, the local station communication devices STA1 to STA8 execute a second determination process of determining whether or not to continue to receive a BC frame.

If the result of the first determination process indicates that the receiving a BC frame is to be continued, the process shifts to step S3.

If the result of the first determination process indicates that the receiving a BC frame is not to be continued, then the local station communication devices STA1 to STA8 execute a process of receiving an MC frame.

In step S7, the local station communication devices STA1 to STA8 execute a third determination process of determining whether or not the received MC frame is required.

If the result of the third determination process indicates that the received MC frame is not required, the process shifts to step S12.

If the result of the third determination process indicates that the received BC frame is required, then in step S8, the local station communication devices STA1 to STA8 execute a fourth determination process of determining whether or not to continue to receive an MC frame.

If the result of the fourth determination process indicates that the receiving an MC frame is to be continued, the process shifts to step S6.

If the result of the fourth determination process indicates that the receiving an MC frame is not to be continued, then in step S9, the local station communication devices STA1 to STA8 execute a process of receiving a UC frame.

In step S10, the local station communication devices STA1 to STA8 execute a fifth determination process of determining whether or not the received UC frame is required.

If the result of the fifth determination process indicates that the received UC frame is not required, the process shifts to step S12.

If the result of the fifth determination process indicates that the received UC frame is required, then in step S11, the local station communication devices STA1 to STA8 execute a sixth determination process of determining whether or not to continue to receive a UC frame.

If the result of the sixth determination process indicates that the receiving an MC frame is to be continued, the process shifts to step S9.

If the result of the sixth determination process indicates that the receiving a UC frame is not to be continued, the process shifts to step S12.

In step S12, the local station communication devices STA1 to STA8 execute an awake-to-doze transition process to switch the awake state to the doze state.

In step S13, the local station communication devices STA1 to STA8 determine whether or not to continue the communication. If the communication is to be continued, the process returns to step S1. If the communication is not to be continued, the process is ended.

The communication system 1 according to the present embodiment as described above allows a reduction in the opportunity of the local station communication devices STA1 to STA8 to receive unnecessary BC and MC frames. This in turn enables a reduction in the power consumption by the local station communication devices STA1 to STA8 and thus in the power consumption in the system.

In the above-described determination processes, to determine whether or not each of the BC and MC frames is required, the local station communication devices STA1 to STA8 reference the MC address. However, AID information, TID information, or the like may be referenced to determine whether or not the BC frame or the MC frame is required.

Furthermore, the center station communication device AP according to the present invention changes order of BC and MC frames for transmission so that BC and MC frames required for the local station communication device STA1 to STA8 are transmitted earlier than those not required for the local station communication devices STA1 to STA8.

Thus, the local station communication devices STA1 to STA8 can collectively receive required BC and MC frames earlier than unnecessary BC and MC frames. This allows a reduction in the duration of the awake state of the local station communication devices STA1 to STA8 and an increase in the duration of the doze state of the local station communication devices STA1 to STA8.

Thus, the opportunity of the local station communication devices STA1 to STA8 to receive BC and MC frames not required for the local station communication device can be reduced. This in turn enables a further reduction in the power consumption by the local station communication devices STA1 to STA8 and thus in the power consumption in the system.

### Second Embodiment

In the above-described first embodiment, upon every receiving a frame, the local station communication device STA references the address (MAC address) to determine whether or not the frame is required. If the received frame is determined to be unnecessary, the local station communication device STA does not receive the subsequent frames even during the communication of BC and MC frames or receives the frames but avoids the continuous execution of the subsequent processing.

In contrast, in the present embodiment, the center station communication device AP transmits, to the local station communication device STA a reference element (reference information) indicative of a timing when the local station communication device STA is to switch from the awake state to the doze state. For the periods of the communication of BC and MC frames and the communication of UC frames, the local station communication device STA determines whether or not the received frame is required, based on the contents of the reference element. The local station communication device STA thus manages the switching from the awake state to the doze state.

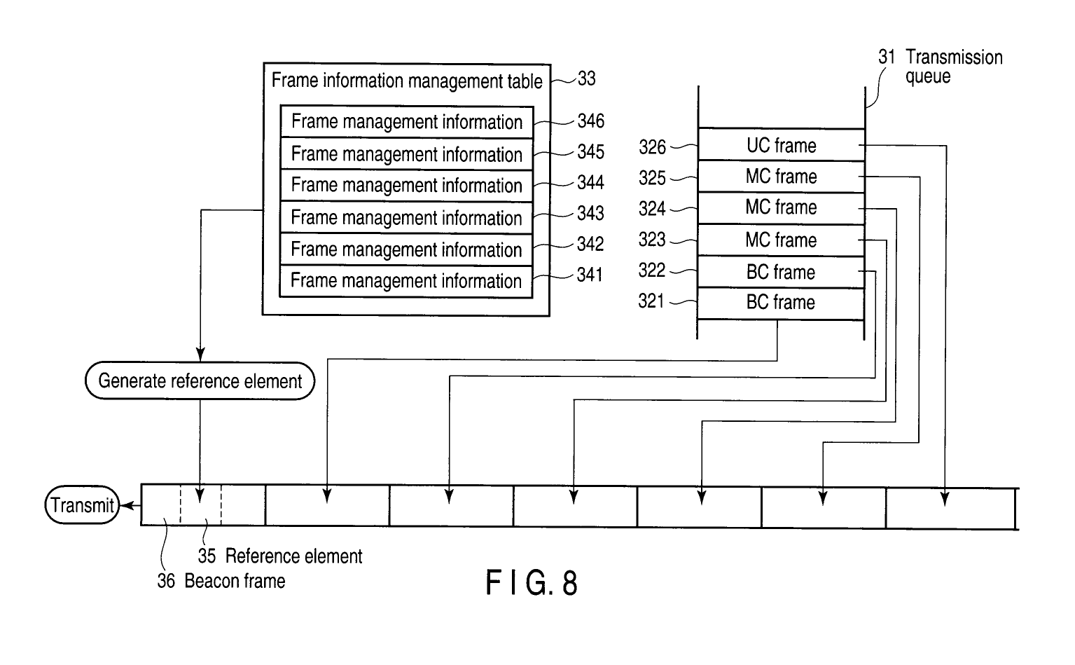

FIG. 8 is a diagram showing a transmission process in the center station communication device AP according to the present embodiment.

BC frames 321 and 322, MC frames 323 to 325, and a UC frame 326 are stored in a transmission queue 31 in the center station communication device AP according to the transmission sequence.

A frame information management table 33 is stored in the storage device in the center station communication device AP. The frame information management table 33 includes pieces of frame management information 341 to 346 corresponding to the BC frames 321 and 322, the MC frames 323 to 325, and the UC frame 326. The pieces of frame management information 341 to 346 indicate which frame is required for which local station communication device STA. Destination information is, for example, a MAC address, AID information, TID information, or the like.

Based on the pieces of frame management information 341 to 346, the center station communication device AP generates, for each local station communication device STA, a reference element 35 specifying switch execution timings required to keep the local station communication device STA awake during the communication of frames to be received, while to keep the local station communication device STA in the doze state during the communication of frames that need not be received.

The center station communication device AP transmits a beacon frame 36 including the reference element 35, and then the BC frames 321 and 322, MC frames 323 to 325, and UC frame 326 stored in the transmission queue 31. The center station communication device AP can also change order of transmission of the BC and MC frames so that the BC and MC frames required for the local station communication device STA are transmitted earlier than those not required for the local station communication device STA.

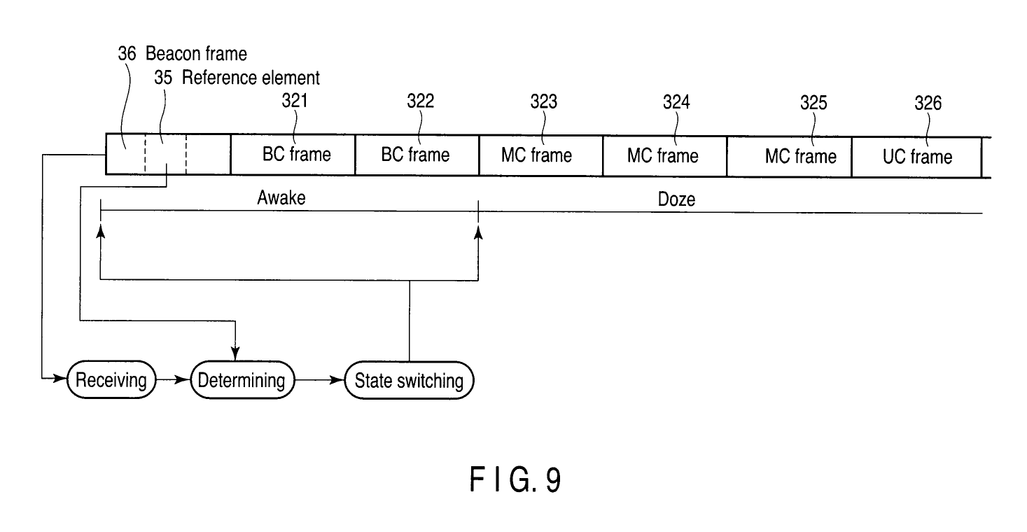

FIG. 9 is a diagram showing a receiving process in the local station communication device STA according to the present embodiment.

The local station communication device STA receives frames from the center station communication device AP to determine whether or not to switch from the awake state to the doze state, based on the reference element 35 in the beacon frame.

According to the result of the determination, the local station communication device STA switches from the awake state to the doze state based on the status of frame reception. Thus, the local station communication device STA performs an operation of receiving frames required for the local station communication device STA, while avoiding receiving or discarding frames not required for the local station communication device STA.

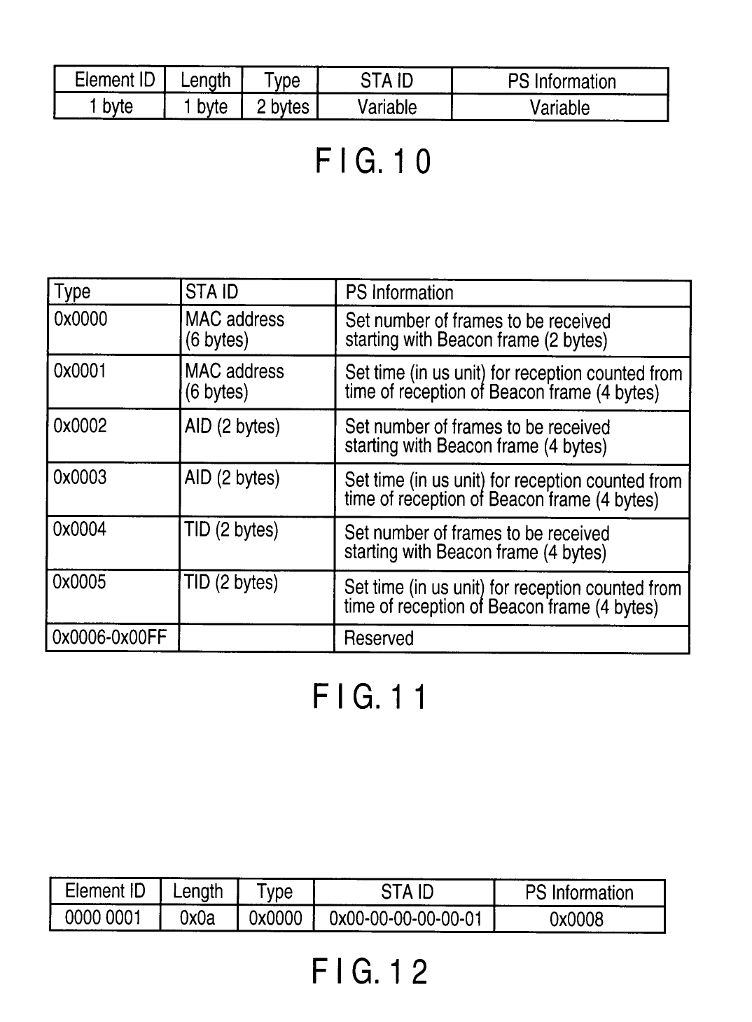

FIG. 10 is a diagram showing an example of the format of the reference element used in the communication system according to the present embodiment.

The reference element includes, for example, an element ID, a length, a type, the ID of the local station communication device (STA ID: the identifier of the local station communication device), and information required to specify a switch timing (power saving [PS] information).

FIG. 11 is a diagram illustrating a method for specifying a local station communication device and a method for specifying a switch timing, for each type of reference element.

FIG. 11 shows that, for example, for a reference element of type “0x0000”, the ID of the local station communication device is specified with an MAC address and the switch timing is specified with the “number of frames to be received starting with the beacon frame”. The method for specifying each type of information is similarly set for other type of reference element.

For a reference element of type “0x0001”, the ID of the target local station communication device is specified with an MAC address and the switch timing is specified with the “time (in μs) at which a frame is to be received and which is counted from the moment of receiving the beacon frame”.

The method for specifying the ID of a local station communication device and the method for specifying a switch timing are similarly set for the other types.

With reference to FIG. 11, the method for specifying the ID of a target local station communication device and the method for specifying a switch timing can be determined based on the type of the reference element.

FIG. 12 is a diagram showing an example of the specific contents of the reference element.

It is assumed that such a reference element as shown in FIG. 12 is received by the local station communication device STA. Here, the ID of each of the plurality of communication devices has a unique value that does not duplicate the ID of any other local station communication device.

Based on the type “0x0000” of the received reference element, the local station communication device STA recognizes that the target local station communication device has an MAC address “0x00-00-00-00-00-01” and needs to receive eight frames (0x0008) succeeding the beacon frame but need not receive the ninth and subsequent frames.

In this case, the local station communication device STA with the MAC address “0x00-00-00-00-00-01” stays awake for a period for the eight frames succeeding the beacon frame. At the ninth and subsequent frames, the local station communication device transitions to the doze state. Here, regardless of whether any of the ninth and subsequent frames transmitted from the center station communication device AP to the local station communication device STA is either a BC frame or an MC frame, the local station communication device transitions to the doze state provided that the frame is not required for the local station communication device STA.

The switch timing can be specified so as to be necessary or unnecessary for the nth to mth frames. In this case, the local station communication device STA is brought into the awake state to receive a required frame or into the doze state for an unnecessary frame.

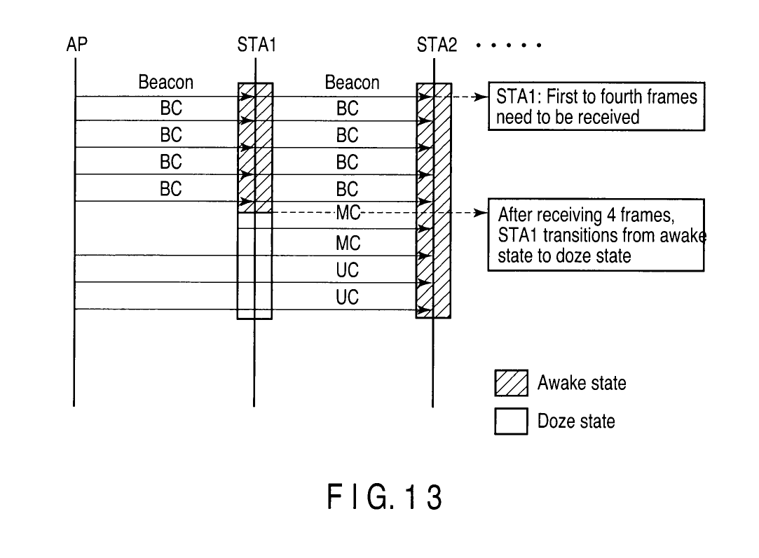

FIG. 13 is a sequence diagram showing an example of communication in the communication system according to the present embodiment. FIG. 13 illustrates the two local station communication devices STA1 and STA2. However, the description below also applies to at least three local station communication devices.

As shown in FIG. 13, the center station communication device AP transmits a beacon frame, four BC frames, two MC frames, and two UC frames to the local station communication devices STA1 and STA2.

The local station communication devices STA1 and STA2 receive the beacon frame transmitted by the center station communication device AP to reference the reference element stored in the beacon frame.

The reference element stored in the beacon frame indicates that for example, the number of frames to be received by the local station communication device STA1 is four.

In this case, the local station communication device STA1 executes a reception process on four frames succeeding the beacon frame, and rejects the receiving the subsequent frames or discards the subsequent frames.

STA2 continues the reception process without changing the state.

In the above-described present embodiment, the reference element indicating the timing at which each local station communication device STA avoids receiving or discards frames is stored in the beacon frame. The center station communication device AP can dynamically change the timing for state switching.

Based on the reference element in the received beacon frame, the local station communication device STA switches the state at the unique timing at which the local station communication device STA is to transition from the awake state to the doze state.

Thus, to receive only required frames (when the center station communication device AP desires to have the local station communication device STA receive only the required frames), the local station communication device STA can be brought into the awake state. The local station communication device STA can otherwise be brought into the doze state. This enables a reduction in the power consumption by the communication device STA.

In particular, if a constant amount of frames are periodically transmitted from the center station communication device AP to the local station communication device STA, the use of the above-described reference element enables a sharp reduction in the power consumption the local station communication device STA not desiring to receive the frames.

### Third Embodiment

In the present embodiment, a variation of the above-described second embodiment will be described.

In the above-described second embodiment, the center station communication device AP transmits the beacon frame including the reference element to the local station communication device.

However, the center station communication device may store the reference element in independent frames (independent management frames) different from the beacon frame, and use the independent management frames to deliver the reference element to the local station communication device.

Furthermore, in the above-described second embodiment, the center station communication device generates a reference element based on the frame information management table 33.

However, the center station communication device may transmit the frame information management table 33 to the local station communication device, instead of the reference element. In this case, based on the frame information management table 33, the local station communication device determines the switch timing for the local station communication device to perform the switching.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication system comprising a center station communication device and local station communication devices,
wherein the center station communication device comprises:
a transmission unit which transmits first data including reference information to the local station communication devices, the reference information being used for switching the local station communication devices from an active state to a waiting state for a period of one-to-many communication in which the center station communication device transmits second data to the local station communication devices, and
each of the local station communication devices comprises:
a receiving unit receiving the first data and the second data from the center station communication device; and
a state switching unit which, for the period of one-to-many communication, switches from the active state to the waiting state based on the reference information.

2. The system according to claim 1, wherein the one-to-many communication is wireless communication, and
the center station communication device further comprises:
a order changing unit changing a transmission order of frames so that a frame to be received by the local station communication devices is received by the local station communication devices before the local station communication devices switches from the active state to the waiting state.

3. The system according to claim 1, wherein wireless LAN communication complying with at least one of IEEE 802.11 standards is performed between the center station communication device and the local station communication devices.

4. The system according to claim 1, wherein each of the local station communication devices comprises:
the receiving unit receiving, from the center station communication device, a frame including the reference information required to switch the local station communication devices from an active state to a waiting state according to at least one of a broadcast communication scheme and a multicast communication scheme;
a determination unit determining, based on the reference information, whether to maintain the active state or to switch to the waiting state according to at least one of the broadcast communication scheme and the multicast communication scheme; and
the state switching unit switching each of the local station communication devices from the active state to the waiting state according to at least one of the broadcast communication scheme and the multicast communication scheme when a result of a determination by the determination unit indicates switching to the waiting state.

5. The system according to claim 1, wherein the center station communication device comprises:
a frame generation unit generating a beacon frame or an independent management frame including the reference information required to switch each of the local station communication devices from the active state to the waiting state according to at least one of a broadcast communication scheme and a multicast communication scheme; and
the transmission unit transmitting the beacon frame or the independent management frame, and a frame used for at least one of the broadcast communication scheme and the multicast communication scheme, to each of the local station communication devices.

6. A wireless communication device performing wireless LAN communication complying with at least one of IEEE 802.11 standards, comprising:
a receiving unit receiving, from a center station communication device, a frame including reference information used for switching a local station communication device from an active state to a waiting state according to at least one of a broadcast communication scheme and a multicast communication scheme;
a determination unit determining, based on the reference information, whether to maintain the active state or to switch to the waiting state according to at least one of the broadcast communication scheme and the multicast communication scheme; and
a state switching unit switching the local station communication device from the active state to the waiting state according to at least one of the broadcast communication scheme and the multicast communication scheme when a result of a determination by the determination unit indicates the switching to the waiting state.

7. The device according to claim 6, wherein the reference information is address information in the frame transmitted from the center station communication device to the local station communication device, and when the reference information indicates the local station communication device, the determination unit determines that the active state is to be maintained, and when the reference information does not indicate the local station communication device, the determination unit determines that the active state is to be switched to the waiting state.

8. The device according to claim 6, wherein the reference information is included in a beacon frame or an independent management frame, and
the receiving unit receives the beacon frame or independent management frame including the reference information, and a frame based on at least one of the broadcast communication scheme and the multicast communication scheme, from the center station communication device.

9. The device according to claim 8, wherein the reference information indicates a timing when the active state is switched to the waiting state.

10. The device according to claim 8, wherein the reference information indicates the number of frames to be received starting with the beacon frame or the independent management frame, or time at which each frame is to be received and which is counted from the time of receiving the beacon frame or the independent management frame.

11. A wireless communication device performing wireless LAN communication complying with at least one of IEEE 802.11 standards, the device comprising:
a frame generation unit generating a beacon frame or an independent management frame including the reference information required to switch a local station communication device from an active state to a waiting state according to at least of one of a broadcast communication scheme and a multicast communication scheme; and
a transmission unit transmitting the beacon frame or the independent management frame, and a frame based on at least one of the broadcast communication scheme and the multicast communication scheme, to a plurality of the local station communication devices.

12. The device according to claim 11, further comprising a order changing unit changing a transmission order of frames according to at least one of the broadcast communication scheme and the multicast communication scheme so that a frame to be received by each of the plurality of local station communication devices at least one of the broadcast communication scheme and the multicast communication scheme is transmitted earlier.

13. The device according to claim 11, wherein the reference information indicates a timing when the active state is switched to the waiting state.

14. The device according to claim 11, wherein the reference information indicates the number of frames to be received starting with the beacon frame or the independent management frame, or time at which each frame is to be received and which is counted from the time of receiving the beacon frame or the independent management frame.
